(19) United States
(12) Patent Application Publication
(10) Pub. No.: US 2025/0146907 A1
(43) Pub. Date: May 8, 2025

(54) SYSTEM AND METHOD FOR MONITORING TIRE HEALTH

(71) Applicant: TuSimple, Inc., SAN DIEGO, CA (US)

(72) Inventors: Xiaoling HAN, San Diego, CA (US); Todd B. SKINNER, San Diego, CA (US); Chiyu ZHANG, Tucson, AZ (US); Yu-Ju HSU, Tucson, AZ (US)

(21) Appl. No.: 18/933,798

(22) Filed: Oct. 31, 2024

Related U.S. Application Data
(60) Provisional application No. 63/596,892, filed on Nov. 7, 2023.

(51) Int. Cl. G01M 17/02; B60W 60/00; G01J 5/48; G01S 17/89; G06T 11/20; G06V 20/56; G07C 5/08

(52) U.S. Cl. CPC G01M 17/027; B60W 60/001; G01J 5/485; G01S 17/89; G06T 11/206; G06V 20/56; B60W 2300/14; B60W 2420/40; B60W 2420/403; B60W 2420/408; B60W 2530/20; G07C 5/0808

(57) ABSTRACT

Techniques are described for monitoring tire conditions on an autonomous vehicle, more specifically, an autonomous truck that includes a tractor unit and a trailer. An example autonomous vehicle includes a tractor unit configured to be coupled to a trailer that comprises multiple tires. The autonomous vehicle may also include one or more infrared sensors. At least part of the one or more infrared sensors is positioned at a rear side of the tractor unit and faced towards the trailer. The one or more infrared sensors are configured to capture one or more heatmaps each representing a temperature distribution of a tire. The one or more infrared sensors are in communication with a control system that is configured to receive the temperature distribution from the one or more infrared sensors, determine a tire condition of the tire, and operate the tractor unit according to the tire condition.

### CROSS-REFERENCE TO RELATED APPLICATIONS

This document claims priority to and the benefit of U.S. Provisional Application No. 63/596,892, filed on Nov. 7, 2023. The aforementioned application of which is incorporated herein by reference in its entirety.

### TECHNICAL FIELD

This document relates to systems, apparatus, and methods for monitoring tire conditions on an autonomous vehicle including a tractor and a trailer.

### BACKGROUND

A vehicle may include sensors for several purposes. For example, sensors may be installed on the roof of a vehicle to facilitate autonomous driving. Sensors can obtain data related to one or more areas that surround a vehicle. As another example, sensors may be installed on the back of the vehicle to monitor road conditions and provide information about the vehicle. The sensor data can be processed to obtain information about the road, the components coupled to the autonomous vehicle, or about the objects surrounding the autonomous vehicle. Thus, the sensor data obtained from the sensors on an autonomous vehicle can be processed or analyzed in real-time to safely maneuver the autonomous vehicle through traffic or on a highway.

### SUMMARY

Disclosed are devices, systems and methods for monitoring tire conditions on an autonomous vehicle, more specifically, an autonomous truck that includes a tractor unit and a trailer.

In one aspect, an example autonomous vehicle includes a tractor unit configured to be coupled to a trailer that comprises multiple tires. The tractor unit comprises a control system. The autonomous vehicle may also include one or more infrared sensors. At least some of the one or more infrared sensors may be positioned at a rear side of the tractor unit and faced towards the trailer. The one or more infrared sensors are configured to capture one or more heatmaps each representing a temperature distribution of a tire. The one or more infrared sensors are in communication with the control system. The control system is configured to receive the temperature distribution from the one or more infrared sensors, determine one or more heatmaps based on the temperature distribution, determine a tire condition of the tire based on the one or more heatmaps, and operate the tractor unit according to the tire condition.

In another example, an example method for monitoring tire health of an autonomous vehicle comprising a tractor unit includes coupling a trailer to the tractor unit of the autonomous vehicle, wherein the trailer comprises multiple tires and operating the trailer, by a control system of the trailer, to drive the autonomous vehicle on a road. The method includes monitoring, by one or more infrared sensors coupled to a rear side of the tractor unit, a temperature distribution of at least one of the multiple tires of the trailer. The temperature distribution is represented as a heatmap. The method also includes determining a tire condition based on the heatmap and operating the tractor unit according to the tire condition.

In another exemplary aspect, the above-described method is embodied in a non-transitory computer readable storage medium. The non-transitory computer readable storage medium includes code that when executed by a processor, causes the processor to perform the methods described in this patent document.

The above and other aspects and features of the disclosed technology are described in greater detail in the drawings, the description and the claims.

### BRIEF DESCRIPTION OF THE DRAWINGS

FIG. 1 is an example of a vehicular computational platform.

FIG. 2 illustrates an example configuration of an autonomous vehicle with IR sensors in accordance with one or more embodiments of the present technology.

FIG. 3 illustrates another example configuration of an autonomous vehicle with IR sensors in accordance with one or more embodiments of the present technology.

FIG. 4A illustrates an example heatmap indicating temperature distributions of two tires in accordance with one or more embodiments of the present technology.

FIG. 4B illustrates example heatmaps indicating temperature distributions of two tires in accordance with one or more embodiments of the present technology.

FIG. 5A illustrates an example heatmap having a temperature spike in accordance with one or more embodiments of the present technology.

FIG. 5B illustrates example heatmaps having a temperature spike in accordance with one or more embodiments of the present technology.

FIG. 6 illustrates an example schematic diagram of a processing system in accordance with one or more embodiments of the present technology.

FIG. 7 is a flowchart representation of an example method for monitoring tire health of an autonomous vehicle comprising a tractor unit in accordance with one or more embodiments of the present technology.

FIG. 8 is another flowchart representation of a tire monitoring method in accordance with one or more embodiments of the present technology.

### DETAILED DESCRIPTION

Section headings are used in the present document for ease of cross-referencing and improving readability and do not limit scope of disclosed techniques. Furthermore, various image processing techniques have been described by using examples of self-driving vehicle platform as an illustrative example, and it would be understood by one of skill in the art that the disclosed techniques may be used in other operational scenarios also (e.g., surveillance, medical image analysis, image search cataloguing, etc.).

The transportation industry has been undergoing considerable changes in the way technology is used to control vehicles. A semi-autonomous and autonomous vehicle is provided with a sensor system including various types of sensors to enable a vehicle to operate in a partially or fully autonomous mode.

### 1. Example Vehicular Computational Platform

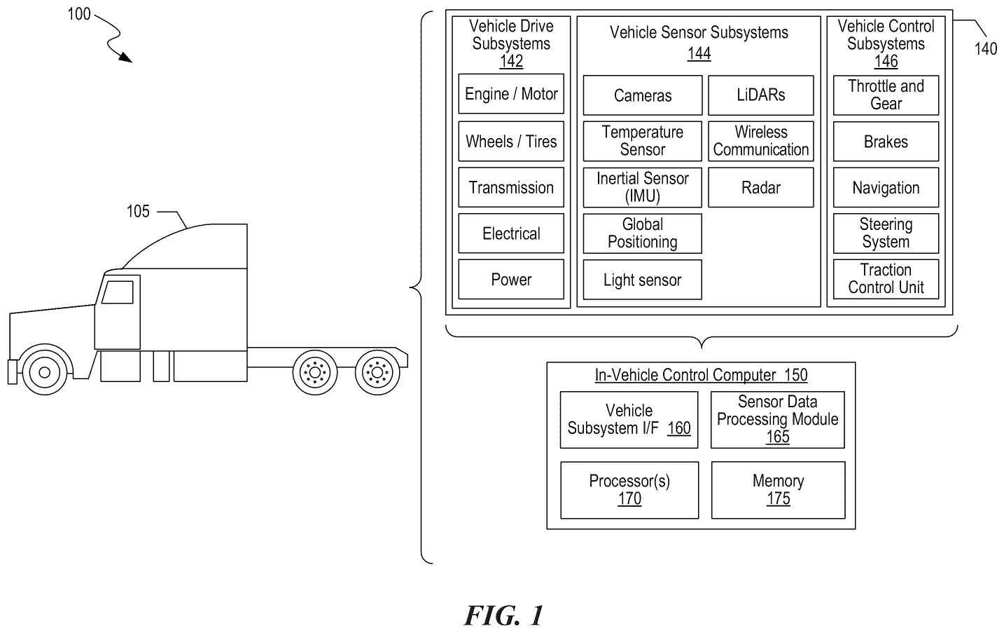

One example use of the proposed method is in the field of autonomous vehicle navigation. FIG. 1 shows a system 100 that is included by an autonomous (self-driving) or semi-autonomous vehicle 105. The vehicle 105 includes a plurality of vehicle subsystems 140 and an in-vehicle control computer 150. The plurality of vehicle subsystems 140 includes vehicle drive subsystems 142, vehicle sensor subsystems 144, and vehicle control subsystems. An engine or motor, wheels and tires, a transmission, an electrical subsystem, and a power subsystem may be included in the vehicle drive subsystems. The engine of the vehicle 105 may be an internal combustion engine, a fuel-cell powered electric engine, a battery powered electrical engine, a hybrid engine, or any other type of engine capable of moving the wheels on which the vehicle 105 moves. The vehicle 105 has multiple motors or actuators to drive the wheels of the vehicle, such that the vehicle drive subsystems 142 include two or more electrically driven motors. The transmission may include a continuous variable transmission or a set number of gears that translate the power created by the engine into a force that drives the wheels of the vehicle. The vehicle drive subsystems may include an electrical system that monitors and controls the distribution of electrical current to components within the system, including pumps, fans, and actuators. The power subsystem of the vehicle drive subsystem may include components that regulate the power source of the vehicle.

Vehicle sensor subsystems 144 can include sensors for general operation of the vehicle 105, including those which would indicate a malfunction in the AV or another cause for an AV to perform a limited or minimal risk condition (MRC) maneuver. The sensors for general operation of the vehicle may include cameras, a temperature sensor, an inertial sensor (IMU), a global positioning system, a light sensor, a LIDAR system, a radar system, and wireless communications supporting network available in the vehicle 105.

The in-vehicle control computer 150 can be configured to receive or transmit data from/to a wide-area network and network resources connected thereto. A web-enabled device interface (not shown) can be included in the vehicle 105 and used by the in-vehicle control computer 150 to facilitate data communication between the in-vehicle control computer 150 and the network via one or more web-enabled devices. Similarly, a user mobile device interface can be included in the vehicle 105 and used by the in-vehicle control system to facilitate data communication between the in-vehicle control computer 150 and the network via one or more user mobile devices. The in-vehicle control computer 150 can obtain real-time access to network resources via network. The network resources can be used to obtain processing modules for execution by processor 170, data content to train internal neural networks, system parameters, or other data. In some implementations, the in-vehicle control computer 150 can include a vehicle subsystem interface (not shown) that supports communications from other components of the vehicle 105, such as the vehicle drive subsystems 142, the vehicle sensor subsystems 144, and the vehicle control subsystems 146.

The vehicle control subsystem 146 may be configured to control operation of the vehicle, or truck, 105 and its components. Accordingly, the vehicle control subsystem 146 may include various elements such as an engine power output subsystem, a brake unit, a navigation unit, a steering system, and an autonomous control unit. The engine power output may control the operation of the engine, including the torque produced or horsepower provided, as well as provide control of the gear selection of the transmission. The brake unit can include any combination of mechanisms configured to decelerate the vehicle 105. The brake unit can use friction to slow the wheels in a standard manner. The brake unit may include an Anti-lock brake system (ABS) that can prevent the brakes from locking up when the brakes are applied. The navigation unit may be any system configured to determine a driving path or route for the vehicle 105. The navigation unit may additionally be configured to update the driving path dynamically while the vehicle 105 is in operation. In some embodiments, the navigation unit may be configured to incorporate data from the GPS device and one or more predetermined maps so as to determine the driving path for the vehicle 105. The steering system may represent any combination of mechanisms that may be operable to adjust the heading of vehicle 105 in an autonomous mode or in a driver-controlled mode.

The autonomous control unit may represent a control system configured to identify, evaluate, and avoid or otherwise negotiate potential obstacles in the environment of the vehicle 105. In general, the autonomous control unit may be configured to control the vehicle 105 for operation without a driver or to provide driver assistance in controlling the vehicle 105. In some embodiments, the autonomous control unit may be configured to incorporate data from the GPS device, the RADAR, the LiDAR (also referred to as LIDAR), the cameras, and/or other vehicle subsystems to determine the driving path or trajectory for the vehicle 105. The autonomous control unit may activate systems to allow the vehicle to communicate with surrounding drivers or signal surrounding vehicles or drivers for safe operation of the vehicle.

An in-vehicle control computer 150, which may be referred to as a vehicle control unit (VCU), includes a vehicle subsystem interface 160, a driving operation module 168, one or more processors 170, a compliance module 166, a memory 175, and a network communications subsystem (not shown). This in-vehicle control computer 150 controls many, if not all, of the operations of the vehicle 105 in response to information from the various vehicle subsystems 140. The one or more processors 170 execute the operations that allow the system to determine the health of the AV, such as whether the AV has a malfunction or has encountered a situation requiring service or a deviation from normal operation and giving instructions. Data from the vehicle sensor subsystems 144 is provided to in-vehicle control computer 150 so that the determination of the status of the AV can be made. The compliance module 166 determines what action needs to be taken by the vehicle 105 to operate according to the applicable regulations. Data from other vehicle sensor subsystems 144 may be provided to the compliance module 166 so that the best course of action in light of the AV's status may be appropriately determined and performed. Alternatively, or additionally, the compliance module 166 may determine the course of action in conjunction with another operational or control module, such as the driving operation module 168.

The memory 175 may contain additional instructions as well, including instructions to transmit data to, receive data from, interact with, or control one or more of the vehicle drive subsystems 142, the vehicle sensor subsystems 144, and the vehicle control subsystem 146 including the autonomous Control system. The in-vehicle control computer 150 may control the function of the vehicle 105 based on inputs received from various vehicle subsystems (e.g., the vehicle drive subsystems 142, the vehicle sensor subsystems 144, and the vehicle control subsystem 146). Additionally, the in-vehicle control computer 150 may send information to the vehicle control subsystems 146 to direct the trajectory, velocity, signaling behaviors, and the like, of the vehicle 105. The autonomous control vehicle control subsystem may receive a course of action to be taken from the compliance module 166 of the in-vehicle control computer 150 and consequently relay instructions to other subsystems to execute the course of action.

The various methods described in the present document may be implemented on the system 100 described with reference to FIG. 1. For example, one or more processors 170 may be configured to implement the object detection techniques described herein.

### 2. Technical Issues

Traditional tire monitoring systems often include a tire pressure sensor to detect the overall health of the tire. However, in some cases, even when the tire is in an extremely dangerous condition, the pressure of the tire may still be in a normal range until a tire blowout event occurs, leading to catastrophic damages to the vehicle. For trucks that include a tractor unit and a trailer, it is difficult to ensure, given the frequent change of trailers, that pressure sensors are installed properly in the trailer and data from the pressure sensors are properly transmitted back to the tractor unit for timely control of the truck. Yet, unhealthy trailer tires can lead to disastrous events when they blow out. Because no human driver may be present for autonomous vehicles, manual interventions for proper maintenance of the tires may not be available.

The technical solutions presented in this patent document address the above-discussed technical problems, among others. For example, implementations of the disclosed techniques allow continuous or periodic monitoring of tire health to ensure safe and efficient driving of an autonomous truck. The discloses techniques leverage existing and/or dedicated sensors (e.g., infrared IR sensors, cameras, LiDAR sensors etc.) to detect problems associated with tire condition, such as tread wear, tire chunking, cracking, rips, and/or embedded foreign objects such as nails and stores. Upon detection of tire health issues, the autonomous vehicle can be triggered to behave accordingly to avoid further damages (e.g., timely pull over to the side of the roads, prompt maintenance, etc.)

### 3. Example Solutions

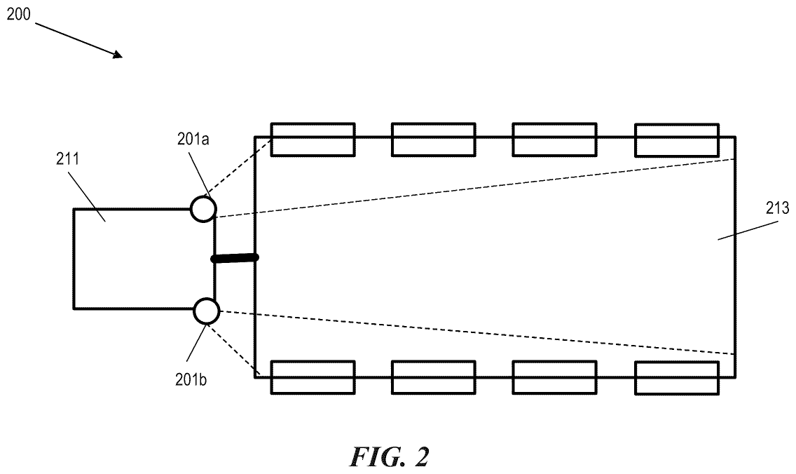

An autonomous vehicle includes multiple sensors (e.g., cameras and/or LiDAR sensors) to capture images of the surroundings of the vehicle. The autonomous vehicle can also include multiple temperature sensors, such as infrared IR sensors, to capture the temperature of the tires. Other sensors can be used to capture additional information about the ambient environment. FIG. 2 illustrates an example configuration of an autonomous vehicle with IR sensors in accordance with one or more embodiments of the present technology. During the operation of the autonomous truck 200, the trailer 213 can be changed quite often, while the tractor unit 211 remains the same for the central control of the truck 200. Each time the trailer 213 changes, cables or communication protocols need to be disconnected, connected, and/or reconfigured. To minimize the overhead for trailer change, it is beneficial to install sensors on the tractor unit 211 to facilitate independent monitoring of the tires of the trailer 213.

In the example configuration shown in FIG. 2, two IR sensors 201a, 201b are installed on the tractor unit 211 of an autonomous truck 200. An IR sensor has internal geometries built into them that create a field of view (FOV). For an IR sensor, the target area that it measures is a combination of the FOV and the distance to the target. The IR sensors 201a, 201b can be installed towards the back of the tractor unit 211 to face towards the trailer 213 and be orientated so that the corresponding FOV can cover the multiple tires in the trailer 213.

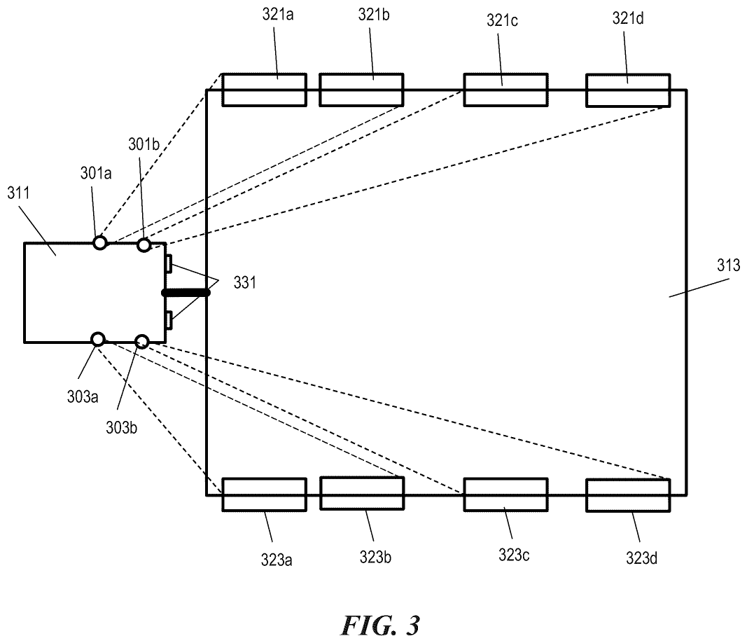

The number of IR sensors and the positions of the IR sensors can be adapted based on the relative sizes of the tractor unit and the trailer, the positions of the trailer tires, as well as the FOV and target distance of the IR sensors. FIG. 3 illustrates another example configuration of an autonomous vehicle with IR sensors in accordance with one or more embodiments of the present technology. In this example, multiple IR sensors 301a, 301b, 303a, 303b are installed on each side of the tractor unit 311 so that each sensor can cover one or more tires on the corresponding side of the trailer 313. For example, sensor 301a is oriented to detect temperature changes of tires 321a, 321b and sensor 301b is oriented to detect temperature changes of tires 321c, 321d. Similarly, sensor 303a is oriented to detect temperature changes of tires 323a, 323b and sensor 303b is oriented to detect temperature changes of tires 323c, 323d. In some embodiments, IR sensors can be installed such that each sensor captures temperature changes of a single corresponding tire.

In some embodiments, each IR sensor is coupled with a motor that is in communication with the in-vehicle control system (e.g., the in-vehicle control computer 150 shown in FIG. 1). Each time the autonomous truck changes its trailer, the in-vehicle control system can control the motors and adjust the orientation of the IR sensors so that the tires of the newly changed trailer can be properly detected by the IR sensors.

In addition to the IR sensors that are configured to detect temperature changes of the tires in the trailer, additional IR sensors can be installed on the tractor unit to detect temperature changes of the tires of the tractor unit. In some embodiments, the additional IR sensors can be fixedly installed on the tractor unit (e.g., without a corresponding motor) because the tires of the tractor unit do not undergo frequent changes. For example, the tractor unit can include two sets of dual tires at its rear end. Rear-side IR sensors can be specifically positioned and oriented to target the dual tires.

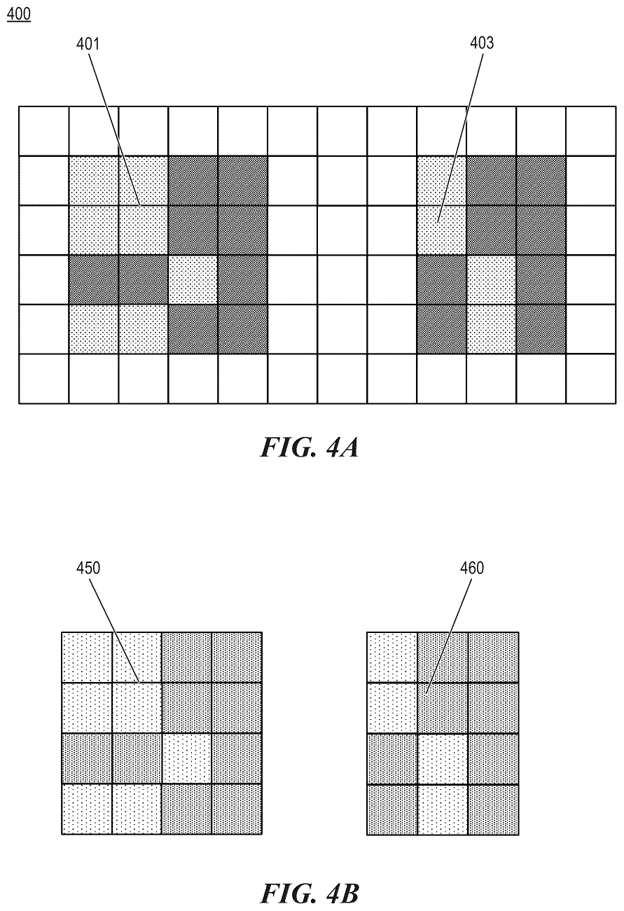

The IR sensors installed on the tractor unit of the autonomous truck can detect the temperature of tires that fall within respective FOVs. In some embodiments, each of the sensors can capture a heatmap representing the temperature distribution of one or more tires. When the tires operate normally, the heatmap indicates a relatively even/uniform distribution. FIG. 4A illustrates an example heatmap 400 indicating temperature distributions of two tires in accordance with one or more embodiments of the present technology. In this example, a heatmap 400 covering the FOV of the IR sensor is generated. Subregions 401, 403 within the heatmap 400 represent the temperature distributions of the two tires. The temperatures are not completely the same across the tire surfaces but are substantially even. In some embodiments, separate heatmaps can be used to represent each of the tires. FIG. 4B illustrates example heatmaps 450, 460 indicating temperature distributions of two tires in accordance with one or more embodiments of the present technology. In this example, each of the heatmaps 450, 460 represents the temperature distribution of a corresponding tire. The shapes of the heatmaps or subregions corresponding to the tires can be same or different based on the position and the angle of the IR sensor with respect to the tires. In some embodiments, an IR sensor can have a resolution of 640×480 or 480×640 pixels for the heatmap to cover multiple tires. Due to the distance between the IR sensor and the target tire sizes, the portions of the heatmap that reflect the temperature distributions of the tires may not occupy a lot of pixels. For example, an average of 800 pixels (e.g., 40×20 pixels or 20×40 pixels) can be used to represent one tire.

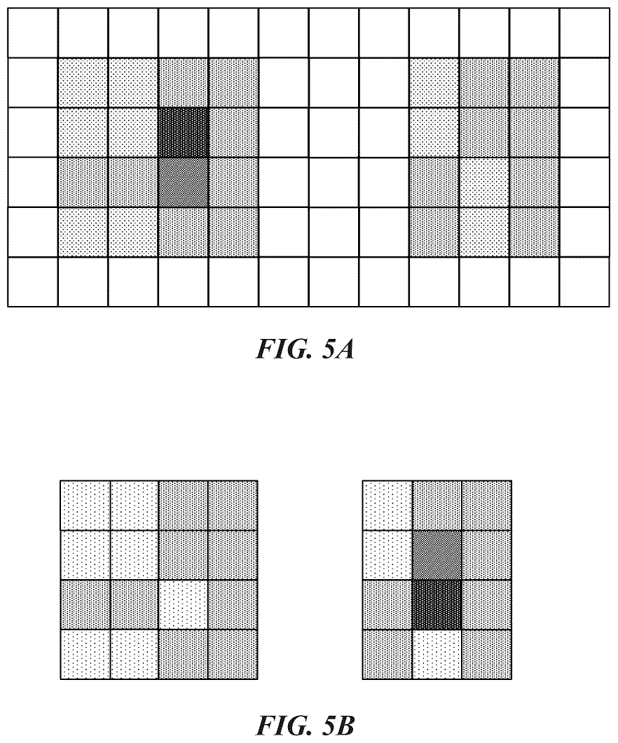

Changes in tires, such as chunking or embedded objects, can cause abnormal changes in tire temperatures. FIG. 5A illustrates an example heatmap having a temperature spike in accordance with one or more embodiments of the present technology. FIG. 5B illustrates example heatmaps having a temperature spike in accordance with one or more embodiments of the present technology. The temperature spikes indicate that there are abnormalities with the tires. For example, when tire chunking occurs, small pieces of rubber start to come off the tire, leading to loss of traction on the roads. These types of changes are very difficult to detect even with visual inspection. However, the loss of rubber also causes uneven distribution of the tire surface temperatures (e.g., the part of the tire with less rubber may heat up more quickly). Upon the detection of chunking or tear of the tire, the in-vehicle control system can direct the autonomous truck to react accordingly. For example, if the chunking or tear is not severe, the in-vehicle control system can note that a tire change is needed in the next regular maintenance. As another example, if the chunking or tear appears to severe and can interfere with normal operation of the autonomous truck, the in-vehicle control system can immediately pull the truck to the side of the road and transmits a signal so that maintenance team can be dispatched to the truck's location.

As another example, when a small foreign object such as a metal piece gets embedded into the tire, the foreign object may not deflate the tire to trigger tire pressure alarms. The difference in thermal conductivity, however, can lead to different surface temperatures when the truck is in operation. Such changes can result in temperature spikes in the detected heatmap(s), thereby enabling timely detection of the tire conditions by the in-vehicle control system. In some embodiments, upon the detection of the foreign objects by the IR sensors, the autonomous truck can be directed to the closest maintenance facility to perform further inspections of the tires, including usage of an inductance sensor, so that the foreign objects can be more accurately identified and removed from the tires (or the tires can be replaced). In some embodiments, an inductance sensor (e.g., an external nail detector) can be installed close to the launching/landing pad or a freight transfer station to detect foreign objects such as metal pieces into the tire. The detection of such foreign objects can trigger a system maintenance such that the objects can be removed or the tires to be exchanged. It is noted that, because the truck body is made of metal, the inductance sensor needs to be positioned close to the tires to avoid or minimize the interference from the metal body. For example, the inductance sensor can be implemented as a landing pad for the trucks to pass through. The landing pad is in contact with the tires and the ground, and far away from the metal truck body, so that the detection of foreign objects can yield more reliable results.

In some embodiments, a data-driven algorithm can be implemented the in-vehicle control system. The algorithm can include an artificial intelligence model that is trained to recognize different heatmaps corresponding to temperature distributions of various scenarios. Training data that corresponds to different scenarios, including operations within a normal temperature range (e.g., 50-90° F.), operations in an elevated temperature range (e.g., above 100° F.), operations on paved roads, operations on unpaved roads (e.g., with lots of debris), can be fed into the model. Additional data, such as tire temperature data captured when the tires are close to fail, can be used in the training. The training data can be annotated to include the appropriate tags to enable the in-vehicle control system to recognize certain characteristics in the heatmaps as indicators of tire health issues. Once trained, the model can help the in-vehicle control system to recognize whether the tires are in a good health condition, have minor issues that need maintenance, or are close to fail.

In some embodiments, the IR sensors can be used in combination with other types of sensors (e.g., cameras, LiDAR sensors) to determine the health of the tires. In particular, leveraging existing sensors that are installed on an autonomous truck to collect images of the tires can improve robustness of the determination of health conditions without much additional cost or overhead. Referring back to FIG. 3, the autonomous truck 300 further includes rear cameras 331 installed at the back of the tractor unit 311. These cameras 331 not only capture images of the road behind the tractor unit and underneath the trailer, but also capture images of the tires of the trailer 313. The in-vehicle control system can be configured to recognize the tire shapes and/or the surface textures of the tires to determine whether there is any chunking or tear that may lead to blowout issues. In some embodiments, the heatmaps and/or regions of the heatmaps can be scaled and/or overlayed onto the captured images from the rear cameras to determine if certain tire conditions have occurred (e.g., chunking, embedded objects, etc.).

In some embodiments, LiDAR sensors are installed at the rear end of the tractor unit to enable detection of the rear objects as well as the determination of the trailer angle. Data from the LiDAR sensors can also be used to indicate whether there exists an abnormal tire condition (e.g., tire shift). In some embodiments, data from the LiDAR sensors is given a lower weight as compared to data from the cameras and/or IR sensors, as the point cloud from the LiDAR sensors may not be dense enough to fully reflect the changes in the tires. However, when the point cloud indicates that there is a drastic change of the tires, such data acts as an effective supplement to other types of sensor data to enable the in-vehicle control system to make a prompt determination of tire conditions.

In some embodiments, training of the in-vehicle control system uses multi-modality data from the IR sensors, the cameras, and/or the LiDAR sensors to allow the system to recognize a combination of different scenarios, e.g., whether the tires are healthy, whether the tires have relatively minor issues suitable for regular maintenance, and/or whether the tires have severe issues that need immediate attention. The output from the artificial intelligence model can be indicators that correspond to different scenarios that require different levels of attention of the autonomous truck operator/maintenance crew.

As mentioned above, in some embodiments, it is desirable to install the sensors on the tractor unit due to the complexity associated with trailer change. Currently, there also exists a bandwidth limitation between the trailer and the tractor unit with respect to data transmission. The bandwidth limitation results in difficulties in installing additional sensors in the trailer, as data from the additional sensors may not be timely transmitted back to the in-vehicle control system in the tractor unit. For example, transmissions of the IR sensor or LiDAR sensor data to the in-vehicle control system in the tractor unit requires around 100 MB/second per sensor while transmission of the camera images to the tractor unit can take 1 GB/second or more of the bandwidth. Having multiple sensors deployed at the trailer can stress the bandwidth between the trailer and the tractor unit and impact the normal operation of the autonomous truck.

With the development of “smart” trailers—trailers that include on-board control system to make decisions on its own—installing IR sensors on the trailer becomes feasible as the sensor data no longer exacerbate the bandwidth issue. The smart trailer itself can process the IR sensor data (e.g., heatmaps), camera sensor data (e.g., images), and/or LiDAR sensor data (e.g., point cloud) to determine whether some of the trailer tires are in a non-optimal condition. The trailer then transmits an indicator to the tractor unit (e.g., via a wireless communication protocol), which does not take much of the bandwidth, to trigger different reactions of the truck.

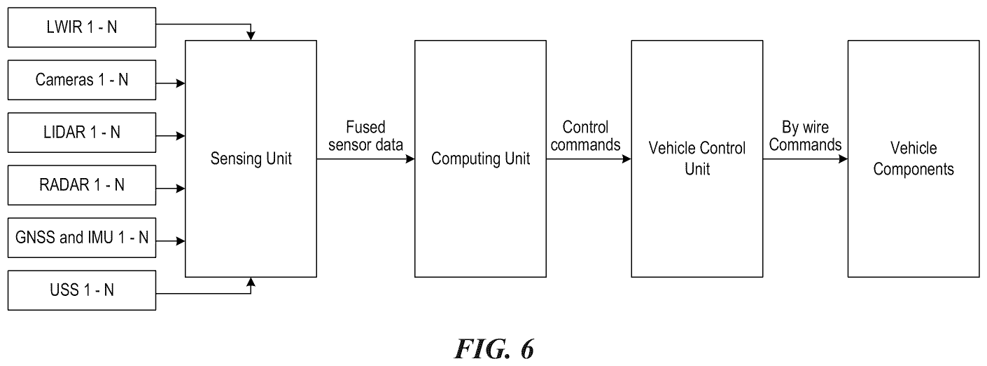

FIG. 6 illustrates an example schematic diagram of a processing system in accordance with one or more embodiments of the present technology. As shown in FIG. 6, a sensing unit is couple to a variety of sensors, including multiple cameras, multiple IR sensors, multiple LiDAR sensors, multiple radar sensors, multiple satellite sensors, and/or multiple ultrasonic sensors. In some embodiments, the sensing unit is configured to fuse the data from the multiple types of sensors together and provide the fused sensor data to the computing unit. Based on the fused sensor data, the computing unit is configured to provide control commands that enable the operation of the vehicle. For example, the vehicle control unit can be configured to issue different commands to different vehicle components to properly operate the vehicle.

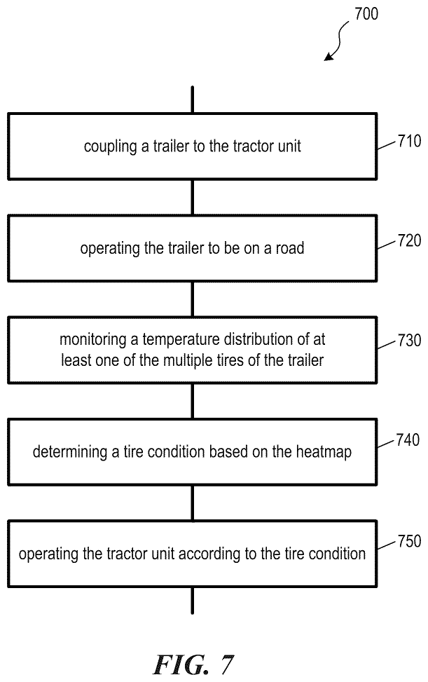

FIG. 7 is a flowchart representation of an example method for monitoring tire health of an autonomous vehicle comprising a tractor unit in accordance with one or more embodiments of the present technology. The method 700 includes, at operation 710, coupling a trailer to the tractor unit of the autonomous vehicle. The trailer comprises multiple tires. The method 700 includes, at operation 720, operating the trailer to be on a road by a control system of the trailer. The method 700 includes, at operation 730, monitoring, by one or more infrared sensors coupled to a rear side of the tractor unit, a temperature distribution of at least one of the multiple tires of the trailer. The temperature distribution is represented as a heatmap. The method 700 includes, at operation 740, determining a tire condition based on the heatmap. The method 700 also includes, at operation 750, operating the tractor unit according to the tire condition.

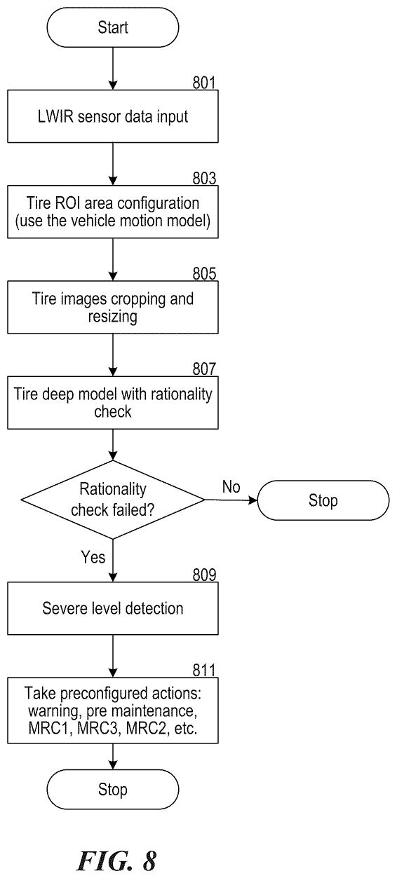

FIG. 8 is another flowchart representation of a tire monitoring method in accordance with one or more embodiments of the present technology. In operation 801, the IR sensor detects the temperature of the tire(s) and provides data input. In some embodiments, as shown in operation 803, the Region of Interest (ROI) of the tire(s) can be configured. The input sensor data is then pre-processed (e.g., cropped and resized) according to the configured ROI, as shown in operation 805. The pre-processed data is fed into a data-driven algorithm (e.g., a deep learning artificial intelligence model) to determine whether the tire(s) can pass the rationality check at operation 807. When the rationality check fails, the algorithm can help determine the severity level of the issue(s) present on the tire(s) at operation 809. Based on the detected severity level, one or more preconfigured actions can be taken at operation 811, including but not limited to issuing a warning to a central control of the vehicle, planning a pre-maintenance of the truck, etc.

Using the disclosed technology, continuous or periodic monitoring of the tire health for a fleet of autonomous trucks becomes feasible. Statistics related to tire blowouts or severe damages to the trucks caused by various tire conditions can indicate the effectiveness of the disclosed techniques.

Some preferred embodiments according to the disclosed technology adopt the following solutions.
1. An autonomous vehicle, comprising: a tractor unit configured to be coupled to a trailer that comprises multiple tires, wherein the tractor unit comprises a control system; one or more infrared sensors, wherein at least some of the one or more infrared sensors are positioned at a rear side of the tractor unit and facing towards the trailer, wherein the one or more infrared sensors are configured to capture a temperature distribution of a tire, wherein the one or more infrared sensors are in communication with the control system, and wherein the control system is configured to: receive the temperature distribution from the one or more infrared sensors, determine one or more heatmaps based on the temperature distribution, determine a tire condition of the tire based on the one or more heatmaps, and operate the tractor unit according to the tire condition.
2. The autonomous vehicle of solution 1, wherein the one or more infrared sensors comprises at least one more infrared sensor positioned close to one or more tires of the tractor unit.
3.The autonomous vehicle of claim 1 or 2, wherein at least one of the one or more infrared sensors is coupled to a motor, wherein the motor is configured to adjust an orientation of an infrared sensor upon a change of the trailer to a second, different trailer.
4. The autonomous vehicle of any of solutions 1 to 3, comprising: one or more cameras positioned at the rear side of the tractor unit and faced towards the trailer, wherein the one or more cameras are configured to capture one or more images of at least one of the multiple tires of the trailer.
5. The autonomous vehicle of any of solutions 1 to 4, comprising one or more LiDAR sensors positioned at the rear side of the tractor unit and faced towards the trailer, wherein the one or more LiDAR sensors are configured to capture one or more point cloud data sets of at least one of the multiple tires of the trailer.
6. The autonomous vehicle of any of solutions 1 to 5, wherein each heatmap comprises one or more subregions, wherein each of the one or more subregions corresponds to a temperature distribution of one of the multiple tires.
7. The autonomous vehicle of solution 6, wherein a resolution of one of the one or more subregions 20×40 pixels or 40×20 pixels.
8. The autonomous vehicle of any of solutions 1 to 7, wherein a resolution of at least one of the one or more heatmaps is 640×480 pixels or 480×640 pixels.
9. The autonomous vehicle of any of solutions 1 to 8, wherein the control system comprises an artificial intelligence model that is trained to recognize, based on the one or more heatmaps, at least one pattern associated with the tire condition.
10. The autonomous vehicle of any of solutions 1 to 9, wherein the control system is configured to operate the tractor unit by: stopping the tractor unit at a location upon determining the tire condition for a tire replacement by a crew.
11. The autonomous vehicle of any of solutions 1 to 10, wherein the control system is configured to operate the tractor unit by: directing the tractor unit to a maintenance facility for an inspection.
12. The autonomous vehicle of any of solutions 1 to 11, wherein the control system is configured to operate the tractor unit by: directing the tractor unit to drive on a landing pad that comprises an inductance sensor for further determination of the tire condition.
13. The autonomous vehicle of any of solutions 1 to 12, further comprising the trailer, wherein the trailer comprises: a second control system, a second set of sensors positioned on the trailer, configured to capture information about a tire condition of at least one of the multiple tires of the trailer, wherein the second control system is configured to transmit an indicator to the control system indicating the tire condition.
14. A method for monitoring tire health of an autonomous vehicle comprising a tractor unit, comprising: coupling a trailer to the tractor unit of the autonomous vehicle, wherein the trailer comprises multiple tires; operating the trailer to be on a road by a control system of the trailer; monitoring, by one or more infrared sensors coupled to a rear side of the tractor unit, a temperature distribution of at least one of the multiple tires of the trailer, wherein the temperature distribution is represented as a heatmap; determining a tire condition based on the heatmap, and operating the tractor unit according to the tire condition.
15. The method of solution 14, comprising: adjusting, by the control system of the tractor unit via one or more motors, the one or more infrared sensors such that the one or more infrared sensors are oriented towards multiple tires of the trailer.
16. The method of solutions 14 or 15, comprising: capturing, by at least a camera or a LiDAR sensor of the tractor unit, data about at least one of the multiple tires of the trailer.
17. The method of solution 16, comprising: generating a combined set of data by overlaying the heatmap with the captured data by the at least the camera or the LiDAR sensor, and determining the tire condition using the combined set of data.
18. The method of any of solutions 14 to 17, comprising: recognizing a pattern of the heatmap, wherein the pattern corresponds to the tire condition.
19. The method of any of solutions 14 to 18, wherein operating of the tractor unit according to the tire condition comprises: directing the tractor unit to a maintenance facility for an inspection or, directing the tractor unit to drive on a landing pad that comprises an inductance sensor for further determination of the tire condition.
20. A non-transitory computer-storage medium having process-executable code that, upon execution, causes one or more processors to implement a method recited in any of solutions 14-19.

### Conclusion

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. In some implementations, however, a computer may not need such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

1. An autonomous vehicle, comprising:
a tractor unit configured to be coupled to a trailer that comprises multiple tires,
wherein the tractor unit comprises a control system;
one or more infrared sensors,
wherein at least some of the one or more infrared sensors are positioned at a rear side of the tractor unit and facing towards the trailer,
wherein the one or more infrared sensors are configured to capture a temperature distribution of a tire,
wherein the one or more infrared sensors are in communication with the control system, and
wherein the control system is configured to:
receive the temperature distribution from the one or more infrared sensors,
determine one or more heatmaps based on the temperature distribution,
determine a tire condition of the tire based on the one or more heatmaps, and
operate the tractor unit according to the tire condition.

2. The autonomous vehicle of claim 1, wherein the one or more infrared sensors comprises at least one more infrared sensor positioned close to one or more tires of the tractor unit.

3. The autonomous vehicle of claim 1, wherein at least one of the one or more infrared sensors is coupled to a motor,
wherein the motor is configured to adjust an orientation of an infrared sensor upon a change of the trailer to a second, different trailer.

4. The autonomous vehicle of claim 3, comprising:
one or more cameras positioned at the rear side of the tractor unit and faced towards the trailer,
wherein the one or more cameras are configured to capture one or more images of at least one of the multiple tires of the trailer.

5. The autonomous vehicle of claim 1, comprising:
one or more LiDAR sensors positioned at the rear side of the tractor unit and faced towards the trailer,
wherein the one or more LiDAR sensors are configured to capture one or more point cloud data sets of at least one of the multiple tires of the trailer.

6. The autonomous vehicle of claim 1, wherein each heatmap comprises one or more subregions,
wherein each of the one or more subregions corresponds to a temperature distribution of one of the multiple tires.

7. The autonomous vehicle of claim 6, wherein a resolution of one of the one or more subregions 20×40 pixels or 40×20 pixels.

8. The autonomous vehicle of claim 7, wherein a resolution of at least one of the one or more heatmaps is 640×480 pixels or 480×640 pixels.

9. The autonomous vehicle of claim 1, wherein the control system comprises an artificial intelligence model that is trained to recognize, based on the one or more heatmaps, at least one pattern associated with the tire condition.

10. The autonomous vehicle of claim 1, wherein the control system is configured to operate the tractor unit by:
stopping the tractor unit at a location upon determining the tire condition for a tire replacement by a crew.

11. The autonomous vehicle of claim 1, wherein the control system is configured to operate the tractor unit by:
directing the tractor unit to a maintenance facility for an inspection.

12. The autonomous vehicle of claim 1, wherein the control system is configured to operate the tractor unit by:
directing the tractor unit to drive on a landing pad that comprises an inductance sensor for further determination of the tire condition.

13. The autonomous vehicle of claim 1, further comprising the trailer,
wherein the trailer comprises:
a second control system,
a second set of sensors positioned on the trailer, configured to capture information about a tire condition of at least one of the multiple tires of the trailer,
wherein the second control system is configured to transmit an indicator to the control system indicating the tire condition.

14. A method for monitoring tire health of an autonomous vehicle comprising a tractor unit, comprising:
coupling a trailer to the tractor unit of the autonomous vehicle, wherein the trailer comprises multiple tires;
operating the trailer to be on a road by a control system of the trailer;
monitoring, by one or more infrared sensors coupled to a rear side of the tractor unit, a temperature distribution of at least one of the multiple tires of the trailer,
wherein the temperature distribution is represented as a heatmap;
determining a tire condition based on the heatmap, and
operating the tractor unit according to the tire condition.

15. The method of claim 14, comprising:
adjusting, by the control system of the tractor unit via one or more motors, the one or more infrared sensors such that the one or more infrared sensors are oriented towards multiple tires of the trailer.

16. The method of claim 14, comprising:
capturing, by at least a camera or a LiDAR sensor of the tractor unit, data about at least one of the multiple tires of the trailer.

17. The method of claim 16, comprising:
generating a combined set of data by overlaying the heatmap with the captured data by the at least the camera or the LiDAR sensor, and
determining the tire condition using the combined set of data.

18. The method of claim 14, comprising:
recognizing a pattern of the heatmap, wherein the pattern corresponds to the tire condition.

19. The method of claim 14, wherein operating of the tractor unit according to the tire condition comprises:
directing the tractor unit to a maintenance facility for an inspection or,
directing the tractor unit to drive on a landing pad that comprises an inductance sensor for further determination of the tire condition.

20. A non-transitory computer-storage medium having process-executable code that, upon execution by one or more processors of an autonomous vehicle, causes the autonomous vehicle to implement a method comprising:
coupling a trailer to a tractor unit of the autonomous vehicle, wherein the trailer comprises multiple tires;
operating the trailer to be on a road by a control system of the trailer;
monitoring, by controlling one or more infrared sensors coupled to a rear side of the tractor unit, a temperature distribution of at least one of the multiple tires of the trailer,
wherein the temperature distribution is represented as a heatmap;
determining a tire condition based on the heatmap, and
operating the tractor unit according to the tire condition.
